(19) United States
(12) Patent Application Publication
(10) Pub. No.: US 2016/0305248 A1
(43) Pub. Date: Oct. 20, 2016

(54) TURBINE COOLING

(71) Applicant: ROLLS-ROYCE plc, London (GB)

(72) Inventors: Keith C. SADLER, Bristol (GB); Frederic GOENAGA, Bristol (GB); Andrew J. MYLREA, Derby (GB)

(73) Assignee: ROLLS-ROYCE plc, London (GB)

(21) Appl. No.: 15/082,416

(22) Filed: Mar. 28, 2016

(30) Foreign Application Priority Data
Apr. 15, 2015 (GB) 1506383.7

(51) Int. Cl. F01D 5/08; F01D 25/12

(52) U.S. Cl. CPC F01D 5/082; F01D 25/12; F05D 2260/20

(57) ABSTRACT

A coolant feed arrangement for delivering coolant to an axially facing surface of a rotor disc configured for carrying a row of turbine blades on its radially outer surface, the coolant delivered through a conduit upstream of the rotor disc, which has an outlet arranged radially inwardly of the blades and directed at the axially facing surface, the arrangement including two or more impediments; at least one impediment including a work extractor device arranged in the conduit to extract work from the coolant on route to a last impediment arranged at or adjacent the outlet, the last impediment including a row of static nozzles configured for accelerating the flow of coolant circumferentially in the direction of rotation of the axially facing surface of the disc whereby to match the speed and direction of rotation of the axially facing surface as the coolant is delivered to the axially facing surface.

### FIELD OF THE INVENTION

The present disclosure concerns the cooling of turbine blades in a gas turbine engine and more particularly to a novel arrangement for supplying cooling air to the blades and discs carrying the blades in the hot part of the engine.

### BACKGROUND OF THE INVENTION

In a gas turbine engine, ambient air is drawn into a compressor section. Alternate rows of stationary and rotating aerofoil blades are arranged around a common axis, together these accelerate and compress the incoming air. A rotating shaft drives the rotating blades. Compressed air is delivered to a combustor section where it is mixed with fuel and ignited. Ignition causes rapid expansion of the fuel/air mix which is directed in part to propel a body carrying the engine and in another part to drive rotation of a series of turbines arranged downstream of the combustor. The turbines share rotor shafts in common with the rotating blades of the compressor and work, through the shaft, to drive rotation of the compressor blades.

It is well known that the operating efficiency of a gas turbine engine is improved by increasing the operating temperature. The ability to optimise efficiency through increased temperatures is restricted by changes in behaviour of materials used in the engine components at elevated temperatures which, amongst other things, can impact upon the mechanical strength of the blades and rotor disc which carries the blades. This problem is addressed by providing a flow of coolant through and/or over the turbine rotor disc and blades.

It is known to take off a portion of the air output from the compressor (which is not subjected to ignition in the combustor and so is relatively cooler) and feed this to surfaces in the turbine section which are likely to suffer damage from excessive heat.

Coolant can be delivered to the turbines and discs in two different ways. A first way uses a stationary component, typically configured to swirl air approaching the rotor disc and terminating in nozzles aimed at the disc surface. An example of such an arrangement is disclosed in U.S. Pat. No. 4,236,869. In such static arrangements, the higher velocity coolant delivered into a coolant chamber at the root of the blade is subjected to significant drag effects as a consequence of a number of static structures bounding the chamber. An alternative way uses a rotating part which can travel with the disc and ducts air directly onto its surface. It is known to use combinations of such methods.

In known stationary arrangements, a row of static nozzles typically have a radius which broadly coincides with that of the root of the turbine blade. Thus cooling air is delivered into the blade at an optimum cooling temperature.

In known rotating arrangements, impellers are provided on the axial surface of the rotating disc or on an adjoining body surface which rotates with the disc. The impellers are configured to, as the disc rotates, draw cooling air delivered near the radially inner edge of the disc radially outwardly towards the turbine blade root.

US Patent Application publication number US2004/0112064 discloses a delivery system for delivering coolant to the roots of blades of a turbine rotor, the system uses a secondary turbine to extract energy from the coolant further reducing the temperature as it is delivered to the blade root. The coolant is delivered to the disc surface via a separate route.

With reference to FIG. 1, a gas turbine engine of prior known construction is generally indicated at 10, having a principal and rotational axis 11. The engine 10 comprises, in axial flow series, an air intake 12, a propulsive fan 13, a high-pressure compressor 14, combustion equipment 15, a high-pressure turbine 16, a low-pressure turbine 17 and an exhaust nozzle 18. A nacelle 20 generally surrounds the engine 10 and defines the intake 12.

The gas turbine engine 10 works in the conventional manner so that air entering the intake 12 is accelerated by the fan 13 to produce two air flows: a first air flow into the high-pressure compressor 14 and a second air flow which passes through a bypass duct 21 to provide propulsive thrust. The high-pressure compressor 14 compresses the air flow directed into it before delivering that air to the combustion equipment 15.

In the combustion equipment 15 the air flow is mixed with fuel and the mixture combusted. The resultant hot combustion products then expand through, and thereby drive the high and low-pressure turbines 16, 17 before being exhausted through the nozzle 18 to provide additional propulsive thrust. The high 16 and low 17 pressure turbines drive respectively the high pressure compressor 14 and the fan 13, each by suitable interconnecting shaft.

Other gas turbine engines to which the present disclosure may be applied may have alternative configurations. By way of example such engines may have an alternative number of interconnecting shafts (e.g. three) and/or an alternative number of compressors and/or turbines. Further the engine may comprise a gearbox provided in the drive train from a turbine to a compressor and/or fan.

A proportion of the air exiting the compressor section is diverted past the combustor through axially extending ducts (not shown) and delivered to components of the turbine section. This air is relatively cooler than that exhausted from the combustion equipment and so serves as a coolant fluid, protecting surfaces of the turbine disc and blades from excessive heat so as to retain mechanical properties of these components and maintain structural integrity of the turbine section.

FIG. 2 shows a prior art coolant feed arrangement of the stationary kind as has been briefly described in the introductory portion of this patent specification. The figure shows, in section, a turbine blade 1 mounted in a recess of a radially outer surface of a turbine disc 2. As can be seen, the root of the blade is provided with an entry port 3 for coolant air which, in use, is distributed through the blade, typically by means of a labyrinth of channels (not shown) extending through the blade body. Annular rim cover plates 4a, 4b enclose the roots of multiple blades 1 engaged in multiple recesses extending around the circumference of the disc 2. On an upstream side of the disc, an annular wall 5 encloses a coolant duct 6 into which air taken off from the compressed supply is delivered. Coolant air exits the duct through an annular nozzle arrangement 7 situated adjacent the disc rim 8. Air exiting the nozzles 7 is directed to the entry port 3 into the blade. Centrifugal force resultant from the rotation of the rotating parts draws the coolant radially outwardly through the labyrinth of cooling channels within the blade body 1.

### SUMMARY OF THE INVENTION

The present invention provides a coolant feed arrangement for delivering coolant to an axially facing surface of a rotor disc which is configured for carrying a row of turbine blades on its radially outer surface, the coolant delivered through a conduit upstream of the rotor disc, the conduit having an outlet arranged radially inwardly of the row of turbine blades and directed at the axially facing surface, the arrangement comprising two or more impediments; at least one impediment comprising a work extractor device arranged in the conduit to extract work from the coolant on route to a last impediment arranged at or adjacent the outlet, the last impediment comprising a row of static nozzles configured for accelerating the flow of coolant circumferentially in the direction of rotation of the axially facing surface of the disc whereby to match the speed and direction of rotation of the axially facing surface as the coolant is delivered to the axially facing surface. The term “impediment” as used herein is intended to encompass any obstacle placed in the path of coolant passing through the conduit whose presence influences the flow characteristics of the coolant.

The term “nozzle” as used herein is intended to encompass an impediment which may comprise perforations, slots, a distribution of radial positions in a wall of the nozzle, a distribution of fins (the fins could optionally have an aerofoil cross section) or the like. Unless explicitly described as static, the nozzles can be rotatably mounted or static.

The last impediment may be located adjacent the outlet. One or more additional impediments may be provided in the conduit and may be (without limitation) nozzles or turbine blade rows.

By suitable selection of impediments, the coolant can be delivered to the blade surface at a speed which matches the speed of rotation of the disc. With a knowledge of the flow characteristics and engine configuration, the skilled person is able to determine suitable impediment arrangements which will achieve this desired outcome.

An impediment may be connected to a rotating shaft, the rotating shaft may be connected to the rotor disc.

The outlet may be directed axially and/or radially with respect to the rotor disc.

Where multiple work extractor impediments are incorporated, the additional work extractor devices may be all of the same configuration. Alternatively, the multiple work extractor devices may employ different impediment configurations.

Where a work extractor device comprises rotatably mounted nozzles, these are arranged with respect to the dominant direction of coolant flow to rotate thereby extracting work from the flowing coolant.

In some embodiments, the work extractor device comprises an array of rotatably mounted fins. The fins may be arranged at an angle to the direction of flow of the coolant and are caused to rotate as the coolant passes through the gap between adjacent fins. In a further option, the fins have an aerofoil cross section, the work extractor device operating as a turbine driven by the coolant flow.

By introducing the work extraction devices into the conduit, work is extracted from the coolant fluid exiting the compressor, reducing the total pressure and temperature of the coolant fluid before it approaches the last impediment.

In specific embodiments any number of impediments comprising any combination of static and work extraction devices may sit upstream of the last impediment. Taking into account the operating parameters of the engine and nozzle design, these work extractor impediments are selectively configured to extract an amount of work which results in a pressure ratio across the last impediment of static nozzles to provide the acceleration required for the coolant to be at a similar speed to the rotation speed of the disc.

In the prior art static arrangement described above, the higher velocity coolant delivered into a coolant chamber at the root of the blade is subjected to significant drag effects as a consequence of a number of static structures bounding the chamber. Furthermore, the arrangement requires a separate cooling arrangement for cooling the axial facing surface and span of the disc body. By extracting work from the coolant by means of the aforementioned impediments, the coolant feed arrangement of the present invention allows coolant to be delivered to the disc surface at a position significantly radially inward of the blade root. Coolant can thus be washed over and/or through the disc on route to the blade root. A single coolant supply cools the disc and blades in sequence, removing the need for a separate supply for each, thereby extracting the most benefit from this coolant fluid and improving overall efficiency of the engine. Disc cooling can be achieved without increasing the blade feed temperature and so maintain the structural integrity of the turbine.

Work extraction devices can be coupled to the disc body and so rotate with the disc. Over tip leakage of these impediments can be controlled by a seal suitably engineered to operate in the local temperature environment. For example (but without limitation), the seal may be a brush seal, a leaf seal or a labyrinth seal composed of suitably selected materials for the temperature environment.

The arrangement can further comprise a radially extending guide axially adjacent and upstream of the rotor disc which serves to duct coolant delivered to the disc surface from the nozzle exit radially outwardly across the disc surface towards the blade root. The guide is optionally an extension of a rim cover plate extending radially inwardly from the rim to a position adjacent the nozzle exit. An axially downstream face of the guide, facing the axially upstream facing surface of the disc is optionally provided with an array of paddles, impellers or the like. The paddles are configured to, as the disc rotates, draw cooling air delivered near the radially inner edge of the disc radially outwardly towards the turbine blade root. Such an arrangement creates a pressure rise across the disc surface. In an alternative, such paddles can be provided on a separate component, for example, the paddles could be provided on the disc surface or another component arranged between the guide and disc.

Optionally the walls at the nozzle exit may be radially divergent whereby to turn the coolant flow in a radially outward direction adjacent the disc surface.

It will be understood that features of an optimally designed embodiment of the invention are variable and depend on, inter alia, the properties of compressed fluid upstream of the turbine, the turbine section delivery requirements (and consequent size, quantity and geometry of turbine blades) and the disc environment. Variations of the inventive concept can be provided and adapted to suit different requirements and conditions without departing from the scope of the invention. Features which can be adjusted or adapted to suit needs include (without limitation) radii of the work extraction fins, radius of nozzle exit, radial dimensions of the optional guide cover plate, nozzle exit angle, number, quantity and geometry of the optional paddles. The skilled addressee will be familiar with standard equations for turbine work extraction (eg Euler) which, in combination with identified pressure changes in free and forced vortices associated with the engine design could be used to design an optimal coolant feed arrangement in accordance with the invention.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF DRAWINGS

Embodiments will now be described by way of example only, with reference to the Figures, in which:

FIG. 1 is a sectional side view of a gas turbine engine;

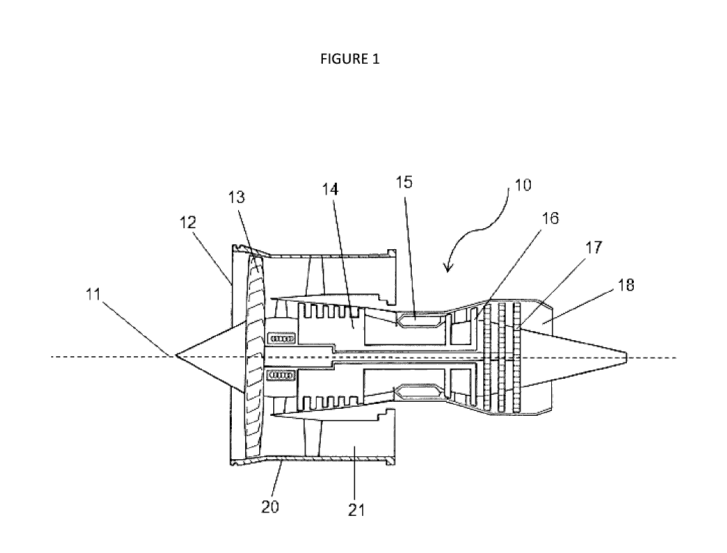

FIG. 2 is a sectional side view of a turbine disc and associated coolant feed system as is known in the prior art;

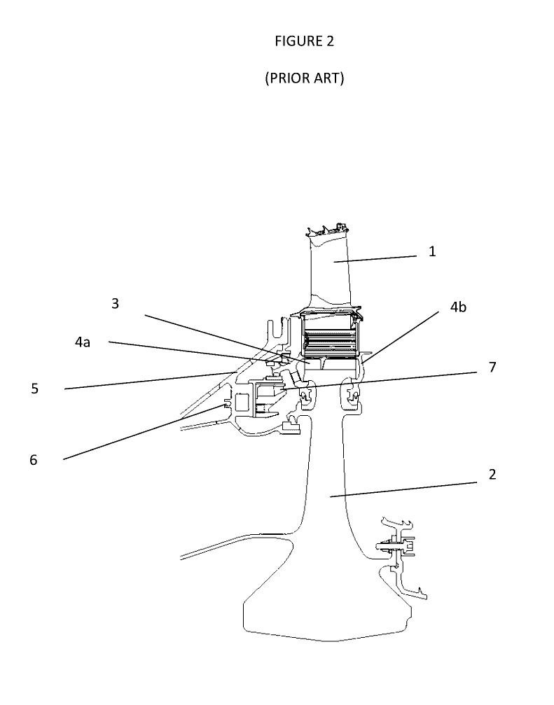

FIG. 3 is a sectional side view of a turbine disc and associated coolant feed system in accordance with an embodiment of the invention;

FIG. 4 is a view of an axially downstream facing surface of a disc cover plate suitable for use in some embodiments of the invention;

### DETAILED DESCRIPTION OF PREFERRED EMBODIMENTS

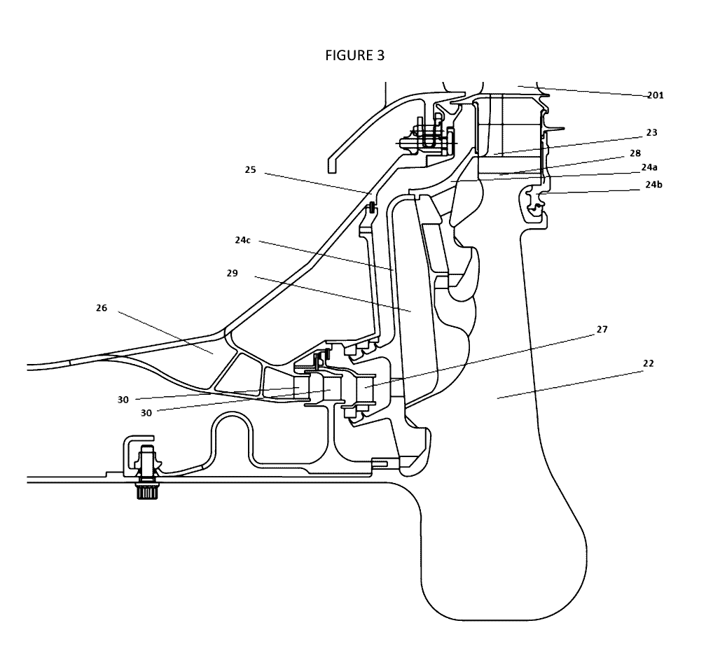

FIG. 3 shows an embodiment of a coolant feed arrangement in accordance with an embodiment of the invention. In common with the prior art arrangement, the figure shows, in section, a turbine blade 201 mounted in a recess of a radially outer surface of a turbine disc 22. As can be seen, the root of the blade is provided with an entry port 23 for coolant air which, in use, is distributed through the blade, typically by means of a labyrinth of channels (not shown) extending through the blade body. Annular rim cover plates 24a, 24b enclose the roots of multiple blades 201 engaged in multiple recesses extending around the circumference of the disc 22. On an upstream side of the disc, an annular wall 25 encloses a coolant duct 26 into which air taken off from the compressed supply is delivered. Rim cover plate 24a extends radially inwardly towards a midpoint on the span of disc 22 and together with an axially oppositely facing wall of the disc 22 creates an annular coolant duct 29 extending radially outwardly of the midpoint to the rim 28 of the disc 22. Immediately axially upstream of the midpoint is provided an annular nozzle arrangement 27 via which coolant air from the duct 26 is delivered to the midpoint positioned entrance of the annular coolant duct 29. Thus coolant air is delivered to the disc 22 radially inwardly of the rim 28. Lower downstream pressure around the blade 201 draws the coolant radially outwardly across the disc surface from where it can be delivered to an entry port in blade 201 for onward passage through an internally arranged labyrinth of cooling channels (not shown) in the blade body. Upstream of the nozzle exit 27 in the duct 26 are located small turbine cascades 30 which extract work from coolant air arriving from the compressor whereby to reduce the static pressure within. Coolant air exiting the most downstream of the work extraction devices (small turbine cascades) is then delivered to nozzle arrangement 27 which is configured then to accelerate the flow of the coolant air circumferentially to match as near as possible the rotational speed of disc 22.

It is to be understood that the term “midpoint” (the radial position at which coolant enters the coolant duct 29), requires a broad interpretation and covers a range of radial positions located between the engine centre line and up to the rotor rim. Within the constraints imposed by factors such as; the properties of compressed fluid upstream of the turbine, the turbine section delivery requirements (and consequent size, quantity and geometry of turbine blades) and the disc environment, it is desirable to locate the midpoint as radially inwardly as is practical. Benefits of the “midpoint” being positioned radially inwardly of the rim have been discussed herein.

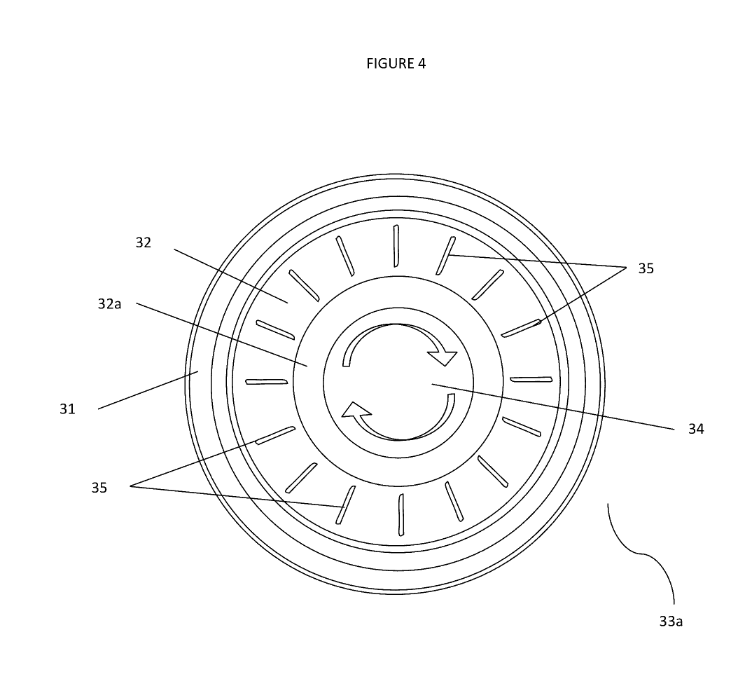

FIG. 4 shows optional features for an upstream rim cover plate (for example rim cover plate 24a and front cover plate 29) for use in an arrangement in accordance with the invention. As can be seen in the figure, the plate (generally designated 34a) is generally annular and has a radially outer stepped section 31 for enclosing the rim of a turbine disc (not shown), a radially inwardly extending midsection 32, 32a and a radially inner orifice 34 through which, in use, the rotor shaft for rotating the disc will pass.

As is visible in the comparable plates 24a and 29 of FIG. 3, the midsection 32, 32a of the plate diverges in an axially upstream direction at its radially most inner end 32a. The midsection surface 32 is provided with an annular array of paddles 35 which incline towards the direction of rotation of the plate, represented by the arrows. When in coaxial alignment with a turbine disc, the midsection 32, 32a serves as a wall of a duct. Coolant air exiting a nozzle such as nozzle arrangement 27 is delivered to the radially outer perimeter of orifice 33 and travels radially outwardly across the disc span and across midsection 32, 32a. As the plate 34a and disc rotate, the paddles 35 scoop air travelling radially across the disc span providing an increased pressure gradient across the span and drawing the coolant air more rapidly towards the blade, thereby both cooling the disc surface and providing a suitably cool flow of coolant air to the blade.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A coolant feed arrangement for delivering coolant to an axially facing surface of a rotor disc which is configured for carrying a row of turbine blades on its radially outer surface, the coolant delivered through a conduit upstream of the rotor disc, the conduit having an outlet arranged radially inwardly of the row of turbine blades and directed at the axially facing surface, the arrangement comprising two or more impediments; at least one impediment comprising a work extractor device arranged in the conduit to extract work from the coolant on route to a last impediment arranged at or adjacent the outlet, the last impediment comprising a row of static nozzles configured for accelerating the flow of coolant circumferentially in the direction of rotation of the axially facing surface of the disc whereby to match the speed and direction of rotation of the axially facing surface as the coolant is delivered to the axially facing surface.

2. A coolant feed arrangement as claimed in claim 1 configured such that coolant delivered to the axially facing surface is directed radially outwardly and enters one or more of the turbine blades at a root of the blade.

3. A coolant feed arrangement as claimed in claim 1 wherein the outlet is arranged radially distant from the radially outer surface, closer to a shaft on which the disc is mounted than the radially outer surface.

4. A coolant feed arrangement as claimed in claim 1 having a work extractor device comprising a rotatably mounted nozzle.

5. A coolant feed device as claimed in claim 1 having a work extractor device comprising an array of rotatably mounted fins arranged at an angle to the direction of flow of the coolant and are caused to rotate as the coolant passes through a gap between adjacent fins.

6. A coolant device as claimed in claim 5 wherein the fins have an aerofoil cross section and the work extractor device operates as a turbine cascade driven by the coolant flow.

7. A coolant feed arrangement as claimed in claim 5 wherein the rotatably mounted fins are coupled to the disc body.

8. A coolant feed arrangement as claimed in claim 5 further comprising one or more seals for sealing against tip leakage at the tips of the fins.

9. A coolant feed arrangement as claimed in claim 8 wherein the seal form is selected from; a brush seal, a leaf seal or a labyrinth seal composed of suitably selected materials for the temperature environment.

10. A coolant feed arrangement as claimed in claim 1 further comprising a radially extending guide axially adjacent and upstream of the rotor disc which serves to duct coolant delivered to the disc surface from the nozzle exit radially outwardly across the disc surface towards the blade root.

11. A coolant feed arrangement as claimed in claim 10 wherein the guide is an extension of a rim cover plate extending radially inwardly from the rim to a position adjacent the nozzle exit.

12. A coolant feed arrangement as claimed in claim 10 wherein on an axially downstream face of the guide, facing the axially upstream facing surface of the disc there is provided an array of paddles, impellers or the like.

13. A coolant feed arrangement as claimed in claim 12 wherein the paddles, impellers or the like are inclined radially in a direction toward the direction of rotation of the blade.

14. A coolant feed arrangement as claimed in claim 1 wherein on an axially upstream face of the disc, there is provided an array of paddles, impellers or the like.

15. A coolant feed arrangement as claimed in claim 14 wherein the paddles, impellers or the like are inclined in a direction toward the direction of rotation of the blade.

16. A coolant feed arrangement as claimed in claim 1 wherein the walls at the static nozzle are radially divergent.

17. A coolant feed arrangement as claimed in claim 1 comprising additional impediments in the form of stationary nozzles.
